(19) United States
(12) Patent Application Publication
(10) Pub. No.: US 2005/0141214 A1
(43) Pub. Date: Jun. 30, 2005

(54) Illuminable decorative floating device

(76) Inventor: Victor M. Fotherby, Lyndhurst (CA)

Correspondence Address: Ralph A. Dowell of DOWELL & DOWELL P.C., 2111 Eisenhower Ave., Suite 406, Alexandria, VA, 22314, US

(21) Appl. No.: 11/015,418

(22) Filed: Dec. 20, 2004

Related U.S. Application Data
(60) Provisional application No. 60/532,739, filed on Dec. 29, 2003.

(51) Int. Cl. F21S 13/12

(52) U.S. Cl. 362/122

(57) ABSTRACT

A floatable, illuminable decorative device, usually in the shape of a flower, is made from a light transparent or translucent flexible thermoplastic material. A light emitting diode powered by a micro cell is sealed within the flower. A water activated switch is mounted in the seal so as to activate the light emitting diode when the device is floated on water.

### FIELD OF INVENTION

This invention relates to an illuminable decorative device, such as a flower, and more specifically to an illuminable decorative floating flower.

### BACKGROUND OF INVENTION AND PRIOR ART

Floating decorative devices, such as flowers and water birds such as ducks, which can be illuminated have been well known for many years. Generally, such floating devices have been in the form of floating wax candles of any selected design. Such candles have limited visual appeal, may represent a serious fire hazard, and have a very limited burning time. Some users may be allergic to either candle smoke or to candle wax. An improved decorative floating device that obviates all or some of the above defects of the prior art has considerable consumer appeal and finds a ready market.

### OBJECT OF INVENTION

It is, therefore, an object of the present invention to provide an improved illuminable floating decorative device that substantially overcomes the defects of the prior art, is relatively inexpensive to manufacture and that can remain illuminated for relatively long periods of time.

### BRIEF STATEMENT OF INVENTION

By one aspect of the present invention, there is provided an illuminable floatable decorative device comprising:
(a) a decorative, substantially hollow, floatable, light transmittable housing;
(b) a light source contained entirely within said housing;
(c) a power source, contained within said housing, to energize said light source;
(d) means to seal said power source and said light source within said housing; and
(e) switch means to control said light source.

### BRIEF DESCRIPTION OF DRAWINGS

FIG. 1 is a perspective view of one embodiment of the present invention;

FIG. 2 is a sectional view, taken along line 2-2, of the embodiment of FIG. 1; and

FIG. 3 is a bottom view of the embodiment of FIG. 1.

### DETAILED DESCRIPTION OF PREFERRED EMBODIMENTS

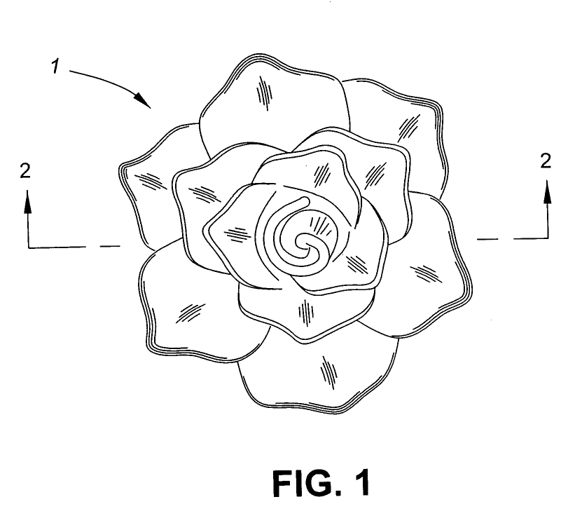

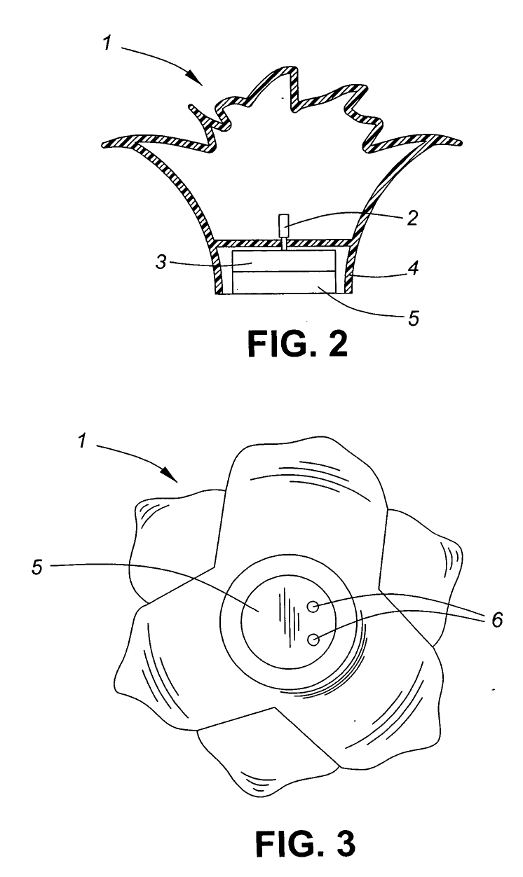

In FIGS. 1-3 there is shown a preferred embodiment of a floating decorative device in the shape and form of a flower, and more particularly in the shape of a rose. It will, however, be appreciated by those skilled in the art that the exact shape of the device is one of design choice and many other flower shapes, such as water lilies, magnolias are equally applicable and within the ambit of the present invention. Similarly, many other shapes, such as animal or bird shapes, or purely abstract art forms are also contemplated by the present invention. The decorative body 1 is generally made by injection moulding of a flexible, translucent or transparent thermoplastics material such as high-density polyethylene or polyvinyl chloride. A multifunctional light, made up from one to three or even more high intensity light emitting diode (LED) bulbs 2, is contained within translucent body 1 and powered by micro cells 3 also contained within the body 1 in a lower housing 4 which is provided with a lower, watertight, seal 5. The LEDs may be programmed to provide a constant, intermittent or fading-in-and-out type of light. The LEDs may be the same or different colours. A control switch 6 controls the ON/OFF function and the functionality of the light. Preferably, but not essentially, switch 6, as shown in FIG. 3, is a water-activated switch. Other types of switches such as pressure, motion or sound or light level activated switches are also contemplated. In operation, the decorative body is simply floated on water, usually contained in a suitable container such as a glass, bowl, or bath but that could equally be a decorative pond, stream, lake or river, and the two contacts 6 of the water activated switch come into electrical contact with each other through the medium of the water. It will be appreciated that distilled or deionised water will may not contain sufficient electrolytes to pass current, but in general municipal or well water contain sufficient dissolved minerals to ensure electrical contact between the contacts. This completes the electrical circuit and the micro cells 3 cause the LEDs 2 to illuminate as programmed and remain illuminated until the device is either removed from the water or the micro cells 3 run down.

1. An illuminable floatable decorative device comprising:
a) a decorative, substantially hollow, floatable and light transmittable housing;
b) a light source contained entirely within said housing;
c) a power source, contained within said housing, to energize said light source;
d) means to seal said power source and said light source within said housing; and
e) switch means to control said light source.

2. An illuminable floatable decorative device as claimed in claim 1 wherein said housing is in the shape of a flower.

3. An illuminable floatable decorative device as claimed in claim 2 wherein said flower is a rose.

4. An illuminable floatable decorative device as claimed in claim 1 wherein said housing is a moulded, flexible thermoplastics housing.

5. An illuminable floatable decorative device as claimed in claim 4 wherein said light source comprises at least one light emitting diode.

6. An illuminable floatable decorative device as claimed in claim 5 wherein said power source comprises at least one micro cell.

7. An illuminable floatable decorative device as claimed in claim 6 wherein said switch means is selected from the group consisting of a water activated switch, a pressure switch, a motion activated switch, a sound activated switch and a light activated switch.

8. An illuminable floatable decorative device as claimed in claim 7 wherein said switch is a water activated switch.

9. An illuminable floatable decorative device as claimed in claim 8 wherein said water activated switch is mounted in said seal means.

10. An illuminable floatable decorative device as claimed in claim 9 wherein said housing is a translucent housing.

11. An illuminable floatable decorative device as claimed in claim 9
wherein said housing is a transparent housing.
